(19) United States
(12) Patent Application Publication
(10) Pub. No.: US 2014/0280057 A1
(43) Pub. Date: Sep. 18, 2014

(54) METHOD AND SYSTEM FOR ANALYZING DATA

(71) Applicant: SAGE CLARITY LLC, Chicago, IL (US)

(72) Inventor: John Oskin, Chicago, IL (US)

(73) Assignee: SAGE CLARITY LLC, Chicago, IL (US)

(21) Appl. No.: 13/839,021

(22) Filed: Mar. 15, 2013

(51) Int. Cl. G06F 17/30

(52) U.S. Cl. CPC G06F 17/30554
USPC 707/722

(57) ABSTRACT

A system and method are described for analyzing and visualizing one or more sets of disparate data. Plural sets of data may be visualized simultaneously. The data set(s) may be visualized in animated form. Plural data sets may be visualized simultaneously in animated form, with such animations running independently or in synchronization.

### BACKGROUND OF THE INVENTION

This invention relates generally to a method and system for retrieving, analyzing, and displaying data in a customizable form via the internet.

One application for the invention is to provide a means for users to review one or more sets of data from one or more data sources (sometimes referred to herein as “variables”) as a function of time. The means may include a user interface in the form of a computer system including a monitor or other display device adapted to display such data. More than one set of data may be displayed at any given time. As such, the invention may synchronize and correlate one set of data with one or more other sets of disparate data. The disparate data may come from separate databases of any type, including SQL, Oracle, flat file, and others. The invention also may involve the identification of periods of interest in the data. These periods of interest may represent inflections and trends in the data that are identified using the invention's algorithms and visualization techniques. The invention further may involve predicting the future state of a given variable based on historical data.

### SUMMARY OF THE INVENTION

A system and method is described for retrieving a first data set representing at least a first variable, displaying the first data set, and correlating the first data set with at least a second data set representing at least a second variable. The system and method may further involve predicting the future state of a third variable based on the present state or postulated future state of at least one of the first and second variables. A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF DRAWINGS

For a better understanding of the invention, reference may be had to the following Figures, which further describe an embodiment of the present invention and which include drawings and exemplary screen shots therefor:

FIG. 1 is a diagram depicting a computer network on which an embodiment of the invention may be operated.

FIG. 2 is a diagram of a remote computer in connection with which an embodiment of the invention may be operated.

FIG. 3 shows an exemplary login page for use in the present invention.

FIG. 4 is a screen shot of a representative dashboard configuration prompt.

FIG. 5 is a screen shot of a representative prompt for selecting a data panel for configuration.

FIG. 6 is a screen shot of a representative prompt for selecting the form of data to be displayed in a data panel selected for configuration.

FIG. 7 is a screen shot showing representative navigation controls.

FIG. 8 is a screen shot showing a representative prompt or control for selecting between synchronized and unsynchronized animation of the data panels.

FIG. 9 is a screen shot showing a representative alert in the form of a pop up indicating that the software application identified a period of interest based on a data point or an aggregation of data being outside the norm.

FIG. 10 is a screen shot showing a representative supplemental data panel providing more detailed data relevant to the inflection point.

FIG. 11 is a screen shot showing a representative prompt for saving a dashboard.

FIG. 12 is a screen shot showing a representative main dashboard screen.

FIG. 13 is a flow chart showing one manner of synchronizing animation of data shown in separate data panels.

FIG. 14 is a flow chart showing one manner of presenting and navigating periods of interest.

FIGS. 15-25 are screen shots showing a representative data animation sequence.

### DETAILED DESCRIPTION

Turning now to the Figures, wherein like reference numerals refer to like elements, there is illustrated a system and method for retrieving, analyzing, displaying, correlating and predicting data via the internet and providing information indicative of the data to a user. Although not required, the system and method will be described in the general context of a computer network 20, as is well know in the industry, and computer executable instructions being executed by general purpose computing devices within the computer network 20. In this regard, the general purpose computing devices may comprise one or more remote computers 30a, and one or more server computers 30b for hosting a software application 50. The server computer 30b may also include one or more databases 32 for storing one or more data sets 40, which will be discussed in more detail below.

To allow each of the remote computers 30a to access the network 20 without storing copies of the software application 50 on each of those computers 30a, the software application 50 may reside on the server computer 30b. Further, it is preferable that users access the software application 50 via an internet browser 40, which acts as an interface between the software application 50 and the operating system for the remote computer 30a. It should be understood that the server computer 30b could employ any one of the currently existing operating systems, including without limitation Windows®, LINUX®, MAC OS®, Mozilla®, etc. In addition, it should be appreciated by those with skill in the art that other applications besides the browser may also be utilized to act as an interface between the software application 50 and the remote computers 30a or that the software application 50 may also reside on the remote computers 30a.

For editing, populating and maintaining the databases 32, the browser 40 may include a graphical user interface 60. As shown in FIG. 3, the graphical user interface 60 may be further comprised of various menu bars, drop-down menus, buttons and display windows, which are well know to those with skill in the art. A detailed description of the graphical user interface 60, the menu bars, drop-down menus, exemplary buttons and display windows, along with a brief description of the functionality associated with those menus, buttons and windows, is described below and in the accompanying Figures.

As should be appreciated, the computers 30a, 30b need not be limited to personal computers, but may include hand-held devices, tablet devices, smart phone devices, multiprocessor systems, microprocessor-based or programmable consumer electronics, minicomputers, mainframe computers, personal digital assistants, cellular telephones, MP3 players, GPS devices or the like depending upon their intended end use within the system. For performing the procedures described hereinafter, the computer executable instructions may be written as routines, programs, objects, components, and/or data structures that perform particular tasks. Within the computer network 20, the computer executable instructions may reside on a single computer 30a, or server computer 30b, or the tasks performed by the computer executable instructions may be distributed among a plurality of the computers 30a, 30b. Therefore, while described in the context of a computer network, it should also be understood that the present invention may be embodied in a stand-alone, general purpose computing device that need not be connected to a network.

To perform the particular tasks in accordance with the computer executable instructions, the computers 30a, 30b may include, as needed, a video adapter, a processing unit, a system memory, and a system bus that couples the system memory to the processing unit. The video adapter allows the computers 30a, 30b to support a display, such as a cathode ray tube (“CRT”), a liquid crystal display (“LCD”), a flat screen monitor, a touch screen monitor or similar means for displaying textual and graphical data to a user. The display allows a user to view information, such as, user information 40a, product information 40b or order information 40c, code, file directories, error logs, execution logs and graphical user interface tools.

The computers 30a, 30b may further include read only memory (ROM), a hard disk drive for reading from and writing to a hard disk, a magnetic disk drive for reading from and writing to a magnetic disk, and/or an optical disk drive for reading from and writing to a removable optical disk or any other suitable data storage device. The hard disk drive, magnetic disk drive, and optical disk drive may be connected to the system bus by a hard disk drive interface, a magnetic disk drive interface, or an optical disk drive interface, respectively, or other suitable data interface. The drives and their associated computer-readable media provide a means of non-volatile storage for the computer executable instructions and any other information 40a, 40b or 40c, data structures, program modules, databases, arrays, etc. utilized during the operation of the computers 30a, 30b.

To connect the computers 30a, 30b within the computer network 20, the computers 30a, 30b may include a network interface or adapter. When used in a wide area network, such as the Internet, the computers 30a, 30b typically include a network interface, such as a router/modem or similar device. The modem, which may be internal or external, is connected to the system bus for the computer via a serial port interface or other communication port. It will be appreciated that the described network connections are exemplary and that other means of establishing a communications link between the computers 30a, 30b may be used. For example, the system may also include a wireless router/modem that receives and transmits information via a wireless communications medium, such as a cellular communications network, a satellite communications network, or another similar type of wireless network. It should also be appreciated that the network interface will be capable of employing TCP/IP, FTP, SFTP, Telnet SSH, HTTP, SHTTP, RSH, REXEC, etc. and other network connectivity protocols.

Those with skill in the art will understand that the software application 50 and databases 32 may reside on the server computer 30b or the remote computer 30a and may be managed and maintained by a provider of the software application 50, a third party, or an end user. The software application 50 and databases 32 may also reside on different computers or more than one computer. The browser 40 may load web pages via HTTP or HTTPS or any other suitable format and displays those web pages on the graphical user interface 60.

For populating the databases 32, the browser 40 may be utilized, but this may also be accomplished via MySQL and other import tools. While the software application 50 may be programmed in any software language capable of producing the desired functionality, it is envisioned that the software application 50 will be programmed using standard programming tools, such as visual basic, JAVA, and XML, among others.

To edit, populate and maintain the databases 32, the graphical user interface 60 may allow the user to perform standard text editing functions, including, mouse placement of the cursor, click-and-drag text selection and standard Windows® key combinations for cutting, copying and pasting data. In addition, the graphical user interface 60 may allow users to access, copy, save, export or send data or files by using standard Windows® file transfer functions. It should be understood that these editing and file transfer functions may also be accomplished within other operating system environments, such as LINUX®, MAC OS®, Mozilla®, etc.

For maintaining the security associated with the software application 50 and databases 32, a unique login window 200 may be maintained for each company/user. The login window 200 may also be used to control the access privileges for various levels of users. Each login window 200 may also require a user name and password. For security purposes, the user names and passwords may be kept separately for each company that is accessing the software application 50. To gain access to the software application 50, the user must enter a proper user name in the user name field 205 and password in the password field 210 and press the submit button 215. The software application 50 may assist users with forgotten user names or passwords. Various methods for retrieving user names and passwords already exist and may be employed in connection with the retrieving and providing to the user the forgotten user name or forgotten password.

It should be appreciated that different login procedures may also be employed, which are well know in the industry, on an as-needed basis, including login procedures that employ biometrics, such as fingerprints, retinal scans, public/private key systems, etc.

Once a user has accessed the software application 50 via the internet and completed the login procedure, the user will be presented with various options for retrieving and reviewing data in a user-customizable manner. A representative login screen is shown in FIG. 3.

For example, the software application 50 could prompt the user to configure the user interface (sometimes referred to herein as a “dashboard”). The software application 50 may be configured to display one or more panels of information (sometimes referred to herein as “data panels”) at a time on the dashboard. Typically, the user would configure the dashboard to display one, two, or four data panels because a typical computer monitor or similar user interface is well-adapted to simultaneously display a single data panel on a full screen, two data panels side-by-side, or four data panels in the four quadrants of the display, as would be understood by one skilled in the art. The configuration prompt may be presented in the form of a pull down menu, a drop box, or other suitable means. FIG. 4 is a screen shot of a representative dashboard configuration prompt including options for:
setting the number of data panels to be displayed in a dashboard;
selecting whether or not periods of interest should be identified to the user during operation of the dashboard, as will be discussed further below;
setting the animation speed, as will be discussed further below; and
setting thresholds for identifying periods of interest, as will be discussed further below.

The software application may prompt the user to select one or more data sets to be displayed in each of the respective panels. These data sets may be from disparate sources, both public and private. Public sources may include government data bases or any other data bases that are available to the public, either without charge or for a fee. Public sources may include databases to which data may be uploaded by the public. Private sources may include any sources that are not generally available to the public, for example, the private records of a business enterprise or an individual.

Each panel may display data representative of a different variable or data set. Alternatively, plural data panels could display data representative of the same variable in different forms, as will be discussed further below. The prompt may be presented in the form of a pull down menu, a drop box, or other suitable means. FIG. 5 is a screen shot of a representative prompt for selecting a data panel for configuration. FIG. 6 is a screen shot of a representative prompt for selecting the form of data to be displayed in a data panel selected for configuration, including options for:
selecting a title for the data panel;
defining the form in which data is to be displayed in the data panel;
selecting units for the x and y axes of a chart to be displayed in the data panel;
selecting data groupings;
selecting the granularity or degree of aggregation of the data to be displayed, as will be discussed further below; and
selecting start and end times for the period in which data is to be retrieved, analyzed, and displayed.

Once a dashboard has been configured, it can be saved for later recall. FIG. 11 is a screen shot showing a representative prompt for saving a dashboard. Saved dashboards can be displayed on a main dashboard screen for selection by a user. FIG. 11 is a screen shot showing a representative main dashboard screen displaying a library of dashboards. Such libraries of saved dashboards (or individual dashboards) may be made accessible to other users of the software application generally, for example, the public-at-large, or to select groups of other users, for example, all or a subset of the employees of a business concern.

Also, once a dashboard has been configured, elements of the dashboard, for example, the contents and format of a given data panel, can be edited as desired. FIG. 12 is a screen shot of a representative prompt for initiating editing of a dashboard. Selection of the “settings” button shown therein could bring up a settings screen such as that shown in FIG. 6 for editing by the user.

The data to be displayed in the panels typically is time-based. As such, the user could select a time period for each of the data sets to be displayed. Data for each time period may be provided in any suitable increments. For example, data may be presented, without limitation, in annual, monthly, weekly, daily, hourly, or other increments, as desired. Each time period may be an aggregation of more granular time periods. For example, the source data may include a large number of data points taken at short intervals, with each data point having a unique time stamp. This source data can be aggregated to represent a summary of the data on a weekly, monthly, yearly or other longer or shorter basis. This aggregated data can be de-aggregated when a period of interest is found, as discussed further below. For example, if a period of interest is identified in the month of May, the aggregated data summary for May could be de-aggregated, for example, in a supplemental data panel, as discussed below, to show individual weeks, days, hours or other time periods during May to allow the user to better understand the data underlying the period of interest.

All of the data sets represented on the dashboard could be set to display data covering the same time period. Alternatively, a first data panel could be set to display data covering a first time period and any additional data panel could be set to display data covering the same or a different time period. Similarly, all of the data sets could display data in similar time increments or different time increments and at the same or different levels of aggregation. See, for example, FIGS. 15-25, wherein the upper twp data panels are set to display data ranging from December 2010 through April 2011 on a monthly basis and the lower two panels are set to display data covering May 1, 2011 through May 6, 2011, on a daily basis.

The variables could relate to any time-based data of interest to the user. For example, in an application wherein the user is interested in analyzing data relevant to a manufacturing concern, the variables could include, without limitation, downtime trend, downtime frequency, production volume mix, and production line configuration.

The software application could prompt the user to select the form in which the data representative of the variables is to be displayed on the dashboard. The software application may be configured to display the data in various ways, for example, in the form of a pie chart, a bar chart, a line graph or chart, a table, a bubble chart, or in other forms, as would be recognized by one skilled in the art. The prompt may be presented in the form of a pull down menu, a drop box, or other suitable means.

The dashboard could include certain features by default. For example, the dashboard could include navigation controls for controlling the display of data in the data panels, as will be discussed further below. The navigation controls could include start, stop, fast forward and rewind controls. The navigation controls could be accessible by means of a key board, a touch screen, or otherwise, as would be understood by one skilled in the art. FIG. 7 is a screen shot showing representative navigation controls.

A user could configure a particular dashboard for analysis and display of a certain set of variables, and another dashboard for analysis and display of another set of variables. As such, the software could be configured to allow the user to configure and save several dashboards and recall them at a later time. The system could prompt the user to save and recall dashboards by means of a pull down menu, a drop box, or other suitable means.

Once the user has configured a dashboard or recalled a saved dashboard, the software application may send a request to a server to retrieve data representative of the selected data sets or variables and the selected time period. The requested data may be displayed in the corresponding panel of the dashboard.

Because the data is time-based, the software application may present the data in animated form. For example, a first panel may be configured to display production volume mix as a function of time in the form of a pie chart. The pie chart may be animated to show how production volume mix changed with time during the time period for which data is provided. A second panel may be configured to show downtime trends as a function of time in the form of a bar chart. The bar chart may be animated to show how downtime changed with time during the time period for which data is provided. A third panel may be configured to display downtime frequency as a function time in the form of a line graph. The line graph may be animated to show how downtime frequency changed with time during the period for which data is provided. Other panels could show similar or other data in similar or other forms.

The first panel may be animated independently of the second panel (and any other panel). Also, the first panel may, but need not, display data covering the same time period as the data displayed in the second panel (or any other panel). As such, the first panel may be animated while the second panel is not animated. Also, the first panel may include data covering a first time period, while the second panel may include data covering a second time period. Further panels may be animated independently from the first and second panels, and they may include data covering further time periods.

Alternatively, the first and second panels (and/or any additional panels) may include data covering the same time period or portions thereof, and they be animated in synchronization to the extent that they include data covering a common time period.

FIGS. 15-25 illustrate the foregoing principles according to one example. In FIGS. 15-25, the upper left data panel shows data relating to product mix in pie chart form on a monthly basis for the time period December 2010 through April 2011. The upper right data panel shows data relating to SAP finished goods performance in bar chart form on a monthly basis for the time period December 2010 through April 2011. The lower left data panel shows data relating to product mix in pie chart form for the time period May 1, 2011 through May 6, 2011 on a daily basis. The lower right data panel shows data relating to May performance in bar chart form for the time period May 1, 2011 through May 6, 2011 on a daily basis. In other examples, any of the data panels could be set to display different data for a different time frame on a more or less granular basis or aggregated basis, as further discussed elsewhere herein. Viewing FIGS. 15-25 in rapid sequence illustrates how the data provided therein may appear in animated form to a user of the software application.

The use of multiple panels in a dashboard allows the software application to correlate changes in a given variable with respect to time with changes to another variable as a function of time and simultaneously display these changes in respective panels. This feature allows a user to see graphically how changes in one variable may affect another variable. This feature is perhaps best illustrated in FIGS. 15-25. Alternatively, each panel may display time based data independently of any other panel. FIG. 8 is a screen shot showing a representative prompt or control for selecting between synchronized and unsynchronized animation of the data panels.

FIG. 13 is a flow chart illustrating one exemplary manner in which the foregoing synchronization may be effected. At step 2610, the synchronization mode is turned on in the software application. At step 2620, the software application determines the earliest start date/time point and the latest ending date-time point for all active graphs. In the example illustrated in FIGS. 15-25, the earliest start date/time point is the December 2010 start point for the two upper data panels, and the latest end time/date point is the May 6, 2011, end point for the two lower data panels. At step 2620, the software application sets all active data panels to display the data for their respective start points. At step 2630, the software application determines whether or not each and every active data panel has been marked as having displayed data for the entire time period for which it was set to display data. If so, the software application deems the animation sequence to be complete at step 2640. If not, the software application determines the next date or time for which data is to be displayed and renders the data for display in the data panels at step 2650. At step 2660, the software application determines for each individual data panel whether the data panel has displayed data for the entire period for which it was set to display data. If so, the software application marks the data panel as finished at step 2670. If any data panel remains not marked as finished the software application returns to step 2630.

The user may use the navigation controls to at any time stop, start, fast forward or rewind the display of animated data. The user may also send animated visual representations of variables via e-mail or otherwise to third parties.

The software application may be configured to identify and alert the user to inflection points and trends in the data, sometimes referred to herein as periods of interest, according to predetermined criteria. An inflection point may be defined to occur, for example and without limitation, when the value of a variable under analysis has trended upward or downward over a predetermined number of successive points in time, when the value of the variable deviates (above or below) from the previous value of the variable by a predetermined number of standard deviations from the norm or a previous data point, or the value of the variable deviates from the previous value of the variable by more than a predetermined percentage. Inflection points may be defined in any other manner, as would be recognized by one skilled in the art. Further, a user may define a period of interest at will while reviewing data presented on the dashboard.

The software application could be configured to alert the user of an inflection point by means of a pop-up box or similar alert, as would be recognized by one skilled in the art, identifying the inflection point as a function of time and the basis for its identification. For example, the software application may alert the user that an inflection point occurred at time t=x and that the inflection point was triggered by data trending upward or downward over, for example, three successive points in time. As another example, the software application may alert the user that an inflection point occurred at time t=x and that the inflection point was triggered by data at that point in time deviating from the norm (or from the previous data point) by three standard deviations. As a further example, the software application may alert the user that an inflection point occurred at time t=x and that the inflection point was triggered by data at that point in time deviating from the norm (or from the previous data point) by more than 20%. The foregoing definitions of the inflection point are merely illustrative and may be selected as desired. FIG. 9 is a screen shot showing a representative alert in the form of a pop up indicating that the software application identified a period of interest based on a data point or an aggregation of data being outside the norm.

The software application may be configured to stop the animation of data when an inflection point is identified, thereby allowing the user to consider the inflection point and other data displayed in other panels on the dashboard at the same time. The user may use the navigation control to restart the animation at any time, or rewind or fast forward the animation, as desired.

The software application may be configured to display a supplemental data panel in response to the identification of an inflection point. The supplemental data panel may appear in the form of a pop-up window, a drop box, or the like. The supplemental data panel may provide additional, for example, more detailed data relevant to the inflection point. For example, if data were to be displayed in a data panel on a monthly basis, the same data could be displayed in the supplemental data panel on a weekly basis. Similarly, weekly data could be drilled down to a daily or more frequent basis, daily data could be drilled down to an hourly or more frequent basis, and so forth. The supplemental data panel could be navigated in the same manner as the base data panel.

FIG. 10 is a screen shot of a representative supplemental data panel providing more detailed data relevant to the inflection point. In FIG. 10, a first arrow points to one of the data points displayed on the supplemental data panel. This data point represents the data point corresponding to (or that caused to be generated) the period of interest. In this example, the period of interest was identified as such because the data value exceeds the norm by more than a predetermined number of standard deviations. The software application could visually distinguish this data point from other data points by presenting this data point in a different color than one or more other data points. For example, this data point could be represented in red, while other data points could be represented in blue. Also in FIG. 10, second and third arrows point to “previous” and “next” controls. A user could actuate these controls to skip to earlier or later periods of interest.

The software application may be configured to identify only a certain number of inflection points during the time period under consideration. For example, ten inflection points might occur during a particular, predetermined time period. The program could be configured to alert the user to only the top five inflection points, for example, the five inflection points involving the five greatest deviations of the variable, or the inflection points involving the greatest number of positively or negatively trending data points.

FIG. 14 is a flow chart illustrating one exemplary manner in which the foregoing identification, alerting, and displaying of information relevant to a period of interest may be effected. At step 2710, a user configures a new dashboard. Alternatively, at step 2715, a user selects, and the software application sends from the user computer to the server a request for a saved dashboard. At step 2720. the software application sends from the user computer to the server a request for data for rendering graphs in the data panels of the requested dashboard. At step 2730, the software application processes the data at the server and identifies a predetermined number of periods of interest. In the FIG. 27 example, the predetermined number is set as five. At step 2740, the software application sends to the user computer data regarding any identified periods of interest. At step 2750, the software application renders graphs at the user computer.

At step 2760, the software application displays the requested data in animated form and determines whether the software application is set to display the periods of interest. If not, the software application completes the data animation normally at step 2770. If so, the software application determines at step 2780 whether the currently displayed data point corresponds to a period of interest. If not, the software application completes the data animation normally at step 2770. If so, the software application renders a supplemental or slave graph displaying detailed information regarding the period of interest at step 2790. The detailed information could include a display of disaggregated data as discussed elsewhere herein. At step 2800, the software application plays the slave graph showing the data therein in animated form. At step 2810, the software application queries the user whether the user would like to replay the slave graph. If so, the software application returns to step 2800. If not, the software application completes the data animation normally at step 2770. At step 2820, the software application determines whether the current data point has been set manually as a period of interest. If so, the software application at step 2830 displays an alert indicating that the current data point has been set manually as a period of interest. The software application also could generate a slave graph providing detailed information relevant to the manually set period of interest, as discussed above in connection with periods of interest identified by the software application.

The software application could be configured to use historical data to predict the future state of one or more variables.

While specific embodiments of the present invention have been described in detail, it will be appreciated by those skilled in the art that various modifications and alternatives to those details could be developed in light of the overall teachings of the disclosure. For example, the processes described with respect to computer executable instructions can be performed in hardware or software without departing from the spirit of the invention. Furthermore, the order of all steps disclosed in the figures and discussed above has been provided for illustrative purposes only. Therefore, it should be understood by those skilled in the art that these steps may be rearranged and altered without departing from the spirit of the present invention. In addition, it is to be understood that all patents discussed in this document are to be incorporated herein by reference in their entirety. Accordingly, the particular arrangement disclosed is meant to be illustrative only and not limiting as to the scope of the invention which is to be given the full breadth of the appended claims and any equivalents thereof.

1-4. (canceled)

5. A method for analyzing and visualizing data, comprising:
retrieving from a first database stored on a computer a first set of data, said first set of data representing a first variable as a function of time over a first time period;
retrieving from a second database a second set of data, said second set of data representing a second variable as a function of time over said first time period;
generating a visual representation of said first set of data as a function of time over said first time period;
generating a visual representation of said second set of data as a function of time over said first time period; and
simultaneously displaying said visual representation of said second set of data in synchronization with said visual representation of said first set of data.

6. The method of claim 5 further comprising displaying said first set of data in a first format and displaying said second set of data in a second format.

7. The method of claim 6 wherein said first format comprises one of a bar chart, a line graph, a pie chart, a bubble chart, and a table, and said second format comprises another one of a bar chart, a line graph, a pie chart, a bubble chart, and a table.

8. The method of claim 5 further comprising:
retrieving from a third database a third set of data, said third set of data representing a third variable as a function of time over a second time period;
generating a visual representation of said third set of data as a function of time over said second time period; and
simultaneously displaying said visual representation of said third set of data.

9. The method of claim 8 further comprising:
displaying said visual representation of said third set of data in synchronization with said visual representation of said first set of data and said visual representation of said second set of data.

10. The method of claim 5 further comprising:
processing said first set of data to identify a first inflection point in said first set of data.

11. The method of claim 10 wherein said first inflection point is defined by a data point of said first set of data deviating from a norm by a predetermined number of standard deviations or a predetermined percentage.

12. The method of claim 10 wherein said first inflection point is defined by a predetermined number of sequential data points of said first set of data trending in a first direction.

13. The method of claim 10 further comprising:
generating a visual representation of data relating to said inflection point as a function of time; and
displaying said visual representation of data relating to said inflection point as a function of time.

14. The method of claim 13 further comprising:
generating said visual representation of said first set of data at a first level of granularity; and
generating said visual representation of data relating to said inflection point a second level of granularity.

15. A system for analyzing and visualizing data, comprising:
a first set of data stored on a computer, said first set of data representing a first variable as a function of time over a first time period;
a second set of data, said second set of data representing a second variable as a function of time over said first time period;
a processor for receiving said first set of data and said second set of data, wherein said processor generates a visual representation of said first set of data as a function of time over said first time period and a visual representation of said second set of data as a function of time over said first time period; and
a display for simultaneously displaying said visual representation of said first set of data in synchronization with said visual representation of said second set of data.

16. The system of claim 15 wherein said processor generates said visual representation of said first set of data in a first format and said processor generates said visual representation of said second set of data in a second format.

17. The system of claim 16 wherein said first format comprises one of a bar chart, a line graph, a pie chart, a bubble chart, and a table, and said second format comprises another one of a bar chart, a line graph, a pie chart, a bubble chart, and a table.

18. The system of claim 15 further comprising:
a third set of data, said third set of data representing a third variable as a function of time over a second time period;
wherein said processor generates a visual representation of said third set of data as a function of time over said second time period; and
said display simultaneously displays said visual representation of said third set of data.

19. The system of claim 18 wherein said display displays said visual representation of said third set of data in synchronization with said visual representation of said first set of data and said visual representation of said second set of data.

20. The system of claim 15 wherein said processor processes said first set of data to identify a first inflection point in said first set of data.

21. The system of claim 20 wherein said first inflection point is defined by a data point of said first set of data deviating from a norm by a predetermined number of standard deviations or a predetermined percentage.

22. The system of claim 20 wherein said first inflection point is defined by a predetermined number of sequential data points of said first set of data trending in a first direction.

23. The system of claim 20 wherein said processor generates a visual representation of data relating to said inflection point as a function of time; and
said display further displays said visual representation of data relating to said inflection point as a function of time.

24. The system of claim 23 wherein said processor generates said visual representation of said first set of data at a first level of granularity and said processor generates said visual representation of data relating to said inflection point a second level of granularity.
